(19) United States
(12) Patent Application Publication
(10) Pub. No.: US 2014/0044227 A1
(43) Pub. Date: Feb. 13, 2014

(54) COMPOSITE BASKET ASSEMBLY

(71) Applicant: Transnuclear, Inc., Columbia, MD (US)

(72) Inventors: Kevin L. Morris, Baltimore, MD (US); Thomas van Riper, Rockville, MD (US); William Bracey, West Orange, NJ (US)

(73) Assignee: Transnuclear, Inc., Columbia, MD (US)

(21) Appl. No.: 13/826,940

(22) Filed: Mar. 14, 2013

Related U.S. Application Data
(60) Provisional application No. 61/682,690, filed on Aug. 13, 2012.

(51) Int. Cl. G21F 5/06

(52) U.S. Cl. CPC G21F 5/06
USPC 376/272; 164/76.1

(57) ABSTRACT

A composite basket assembly (10) for radioactive fuel containment includes a plurality of cask disks (20) disposed together in face-to-face relationship by connecting rods (40) extending through the disks. The disks are formed with interior cells (124) and a grid structure (122) to form discrete compartments for individual fuel assemblies. A neutron-absorbing material (34) is incorporated into the disks to absorb radioactive emissions from the stored fuel.

### CROSS-REFERENCE TO RELATED APPLICATION

This application claims the benefit of U.S. Provisional Application No. 61/682,690, filed Aug. 13, 2012, the disclosure of which is hereby expressly incorporated by reference herein in its entirety.

### BACKGROUND

Canister or cask assemblies are typically used for storing and transporting nuclear fuel. Canister or cask assemblies for fuel include “baskets” for receiving individual fuel assemblies, which are contained within the outer canister. Previously designed baskets are typically constructed from stainless steel plates and aluminum rails that are welded into a basket configuration. Geometric spacing and fixed neutron adsorbers between compartments are used to maintain criticality control. These previously designed baskets are complicated to manufacture, having multiple parts and requiring the work of highly skilled welders. Moreover, these previously designed baskets have not been optimized for efficient heat transfer.

Therefore, there exists an improved basket design in terms of cost, simplicity, and performance. Embodiments of the present disclosure are directed to fulfilling these and other needs.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

A composite basket assembly for receiving and storing a radioactive fuel assembly is composed of a plurality of cast disks constructed from aluminum or aluminum composite, and a neutron-absorbing material. Such disks have first and second faces separated by the thickness of the disk. To form the basket assembly, a plurality of cast disks are disposed in face-to-face relationship to each other and held in place by connecting rods or other means. The disks are formed with a plurality of holes extending through the thickness of the disk, whereupon when the plurality of cast disks are assembled together, the holes of the individual disks are in alignment with each other to define cells extending through the interior of the basket assembly for receiving the radioactive fuel.

The neutron-absorbing material is integrated into the aluminum or aluminum composite composing the disks. Such neutron-absorbing material may include aluminum/boron carbide plates. Other neutron-absorbing materials may include sheets of titanium diboride, and zirconium diboride. The neutron-absorbing material may also be combined with aluminum to form a matrix composed of aluminum and titanium diboride, zirconium diboride, or boron carbide particulates.

The aluminum/aluminum composite disks may be reinforced by one or more materials having a higher strength than aluminum or aluminum composite. Such reinforcing members may include steel in numerous forms, such as rods, bars, mesh. Other reinforcing materials may include boron fiber or carbon fiber. In addition or alternatively, the aluminum composite may include discontinuous reinforcement with silicon carbide, aluminum dioxide, titanium diboride, or boron carbide powders.

### DESCRIPTION OF THE DRAWINGS

The foregoing aspects and many of the attendant advantages of this disclosure will become more readily appreciated as the same become better understood by reference to the following detailed description, when taken in conjunction with the accompanying drawings, wherein:

FIG. 1 is an isometric view of a basket assembly in accordance with one embodiment of the present disclosure;

FIG. 2 is a top view of the basket assembly of FIG. 1;

FIG. 3 is a side view of the basket assembly of FIG. 1;

FIG. 4 is a cross-sectional view of a cask composite layer in accordance with one embodiment of the basket assembly shown in FIG. 1;

FIG. 5 is a front view of expanded steel, one form in which steel may be used in the cask composite layer of FIG. 4;

FIGS. 6 and 7 are isometric view of process steps in a casting process to form the cask composite layer of FIG. 4; and

FIG. 8 is an isometric view of a previously designed basket assembly.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result.

In the following description, numerous specific details are set forth in order to provide a thorough understanding of exemplary embodiments of the present disclosure. It will be apparent to one skilled in the art, however, that many embodiments of the present disclosure may be practiced without some or all of the specific details. In some instances, well-known process steps have not been described in detail in order not to unnecessarily obscure various aspects of the present disclosure. Further, it will be appreciated that embodiments of the present disclosure may employ any combination of features described herein.

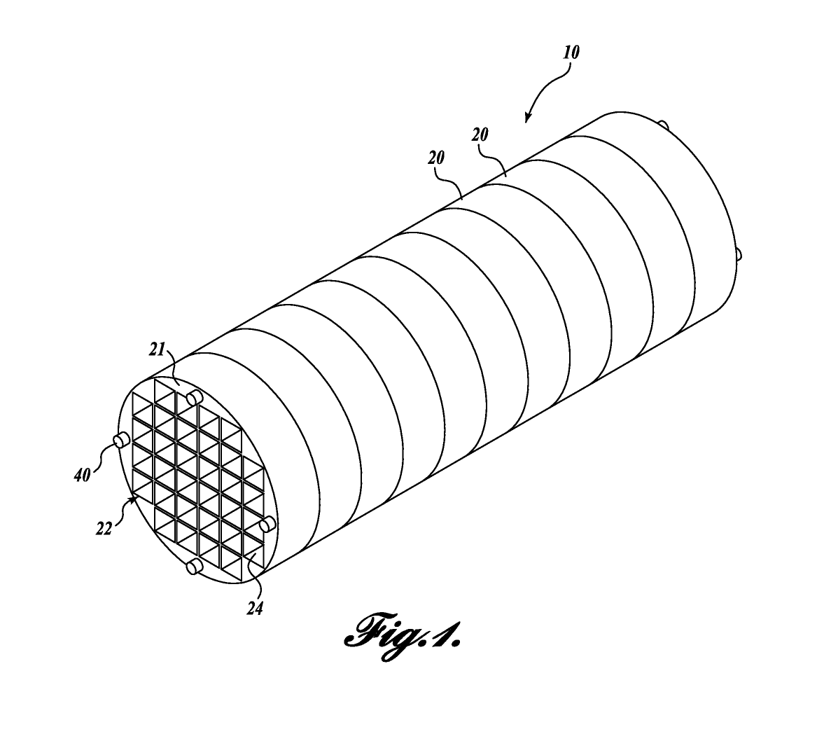

Embodiments of the present disclosure are directed to composite basket assemblies, for example, used for the dry storage and containment of radioactive materials, for example, nuclear fuel, in ventilated canister storage systems, cask storage systems, and transport cask systems. The present disclosure is also directed to methods of manufacturing such basket assemblies. Referring to FIGS. 1-3, a composite basket assembly 10 constructed in accordance with one embodiment of the present disclosure is provided. The composite basket assembly 10 includes a plurality of composite circular disks 20 having faces 21 separated by the thickness of the disk that are stacked together in face-to-face relationship to each other. The plurality of disks 20 is designed to align together when stacked face-to-face to form an interior grid structure 22 defining a plurality of elongate holes 24 for receiving fuel assemblies (not shown). The holes 24 are shown as substantially square in cross section, but can be formed in other cross-sectional shapes. Such a configuration has been found to have several advantages compared to previously designed basket assemblies, including reduced manufacturing costs, reduced manufacturing complexity, and improved performance, as described in greater detail below.

Although the disks are shown as being round in shape, other overall shapes are possible. Such other shapes can include oval, elliptical, or polyhedronal.

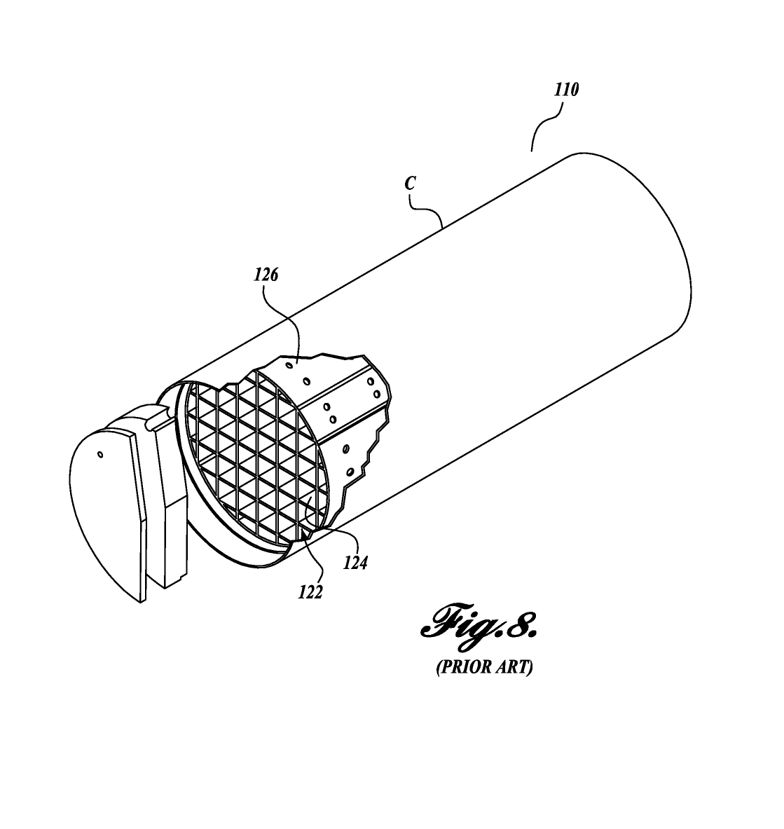

Referring now to FIG. 8, a previously designed basket assembly 110 for a container assembly C is shown. The basket assembly 110 generally defines a plurality of compartments or cells 124 in a grid structure 122, wherein the cells 124 are constructed from individual plates. The cells 124 are configured for supporting individual fuel assemblies (not shown). Contoured longitudinal perimeter rails 126 are formed around the perimeter of the grid structure 122 to provide for an overall cylindrical configuration of the basket assembly 110. The grid structure 122 allows the fuel assemblies to maintain suitable geometric spacing between adjacent fuel containers to reduce the risk of criticality.

The individual cells 124 of the previously designed basket assembly 110 are typically manufactured from stainless steel plates that are welded together into the grid structure 122 defining the plurality of cells 124. Stainless steel plates are used for their structural and metallurgical properties. The plates are resistant to corrosion when used in a wet environment, such as a storage pool. Corrosion can result in structural degradation and/or contamination of the storage pool. The perimeter rails 126 are typically constructed from aluminum. Neutron absorbing plates (not shown) are configured to line the cells 124 of the grid structure 122, particularly between adjacent cells 124; whereby the cells 124 form discrete and shielded longitudinal compartments for individual fuel containers.

Returning to FIGS. 1-3, in accordance with embodiments of the present disclosure, a composite basket assembly 10 is formed using a casting process, instead of a welding process. In metalworking, casting involves pouring liquid metal into a mold, such as a sand casting mold or a permanent mold. The mold maintains a hollow cavity of the desired shape. The mold includes cores or plugs to form the holes 24. The liquid metal is allowed to cool and solidify in the mold. The solidified metal is known as a casting, which can be ejected or otherwise removed from the mold to complete the process. Castings are particularly useful for making complex shapes that would be difficult or uneconomical to make or fabricate by other methods.

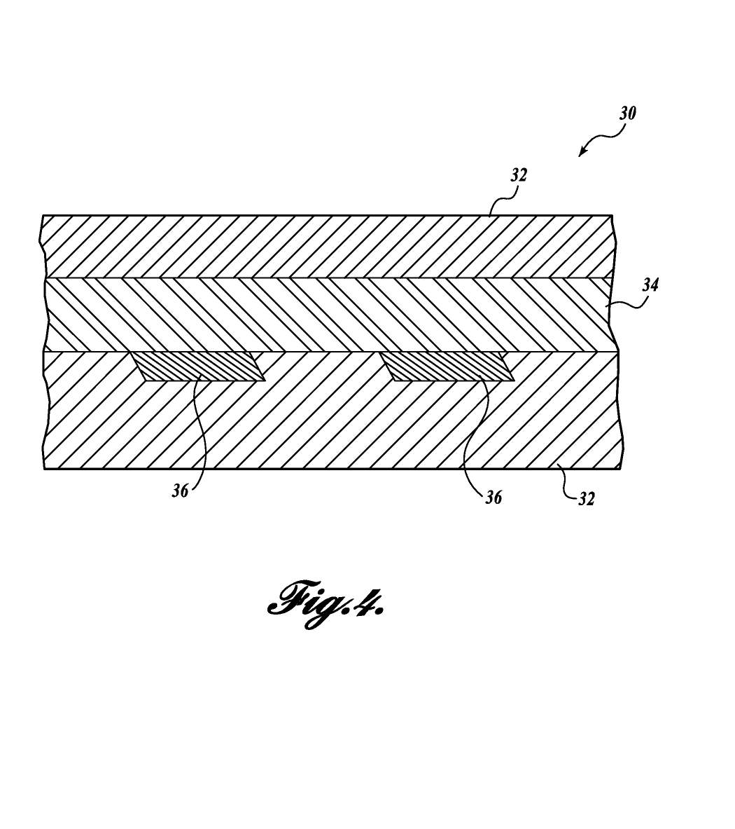

FIG. 4, in accordance with one embodiment of the present disclosure, shows a cast composite 30 composed of aluminum or an aluminum composite 32, surrounding a neutron absorbing material 34 embedded or sandwiched in the aluminum or aluminum composite 32. Although it is possible to produce basket assembly from other materials, aluminum has the advantage of being easy to cast, being of relatively low cost, and being light in weight. The cast composite may also include a reinforcing material or members 36 embedded or otherwise integrated into the casting, such as steel or other material having a higher strength than aluminum or the aluminum composite 32. If steel is embedded in the casting, it is not required to be stainless steel, since the steel will not be exposed, thereby resulting in a cost savings for the overall basket assembly 10. Other reinforcing materials may include high strength fibers such as ceramic fibers, boron fibers, carbon fibers, or other similar fibers. In addition to increasing the tensile strength of the aluminum, the ceramic and other fibers can reduce the coefficient of thermal expansion of aluminum and increase the creep resistance of aluminum. This can be important when the aluminum is heated by nuclear fuel elements. Also, it is to be understood that more than one reinforcing material could be used at the same time.

As a non-limiting example, the aluminum composite 32 is aluminum silicon carbide. Although other aluminum composites may be used, such as aluminum oxide powder, aluminum silicon carbide has the advantage that it has enhanced structural properties, as compared to aluminum and has higher thermal conductivity relative to aluminum oxide powder. Moreover, aluminum silicon carbide has a lower expansion coefficient than aluminum, which is significant, especially when the basket assembly 10 is subjected to high temperatures. In that regard, the coefficient of thermal expansion of aluminum silicon carbide is more compatible with the coefficients of thermal expansion of the other components in the cast composite 30, such as neutron absorbing material 34 and steel 36. The use of materials to construct composite 30 of similar coefficients of thermal expansion can result in reduced stresses on the system both in the casting process and when the basket assembly 10 is loaded with fuel at high temperatures.

Other composite materials may be used in addition to silicon carbide or aluminum oxide powder, for example, titanium diboride, zirconium, diboride, and boron carbide. These additional reinforcing materials have a lower coefficient of thermal expansion than aluminum.

The aluminum composite 32 is typically composed of about 80 to 90% aluminum and correspondingly about 10 to 20% particulate reinforcement material. However, other proportions of aluminum to particulate reinforcement material may be utilized.

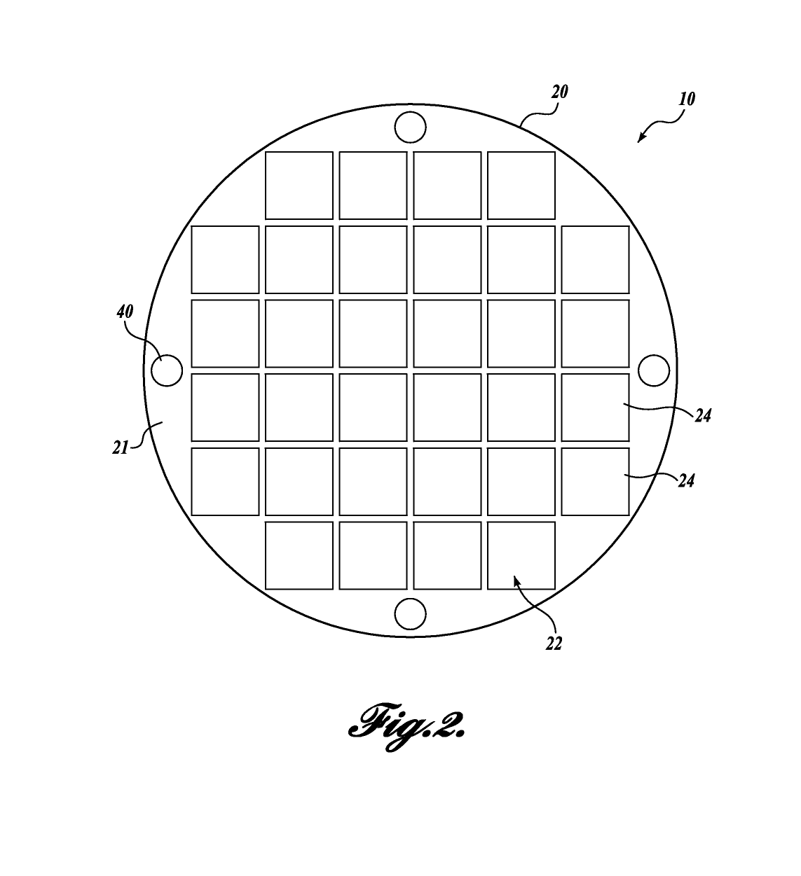

Encased in the aluminum composite matrix 32 is a neutron absorbing material 34, such as aluminum/boron carbide plates In one embodiment of the present disclosure, the composite basket assembly 10 includes neutron absorbing material 34 in the casting composite 30 so as to be positioned between all adjacent cells 24 in the grid structure 22 (see FIG. 2). Other materials can be used as the neutron absorbing material, including hot pressed boron carbide sheet, titanium diboride sheet, and zirconium diboride sheet. Rather than in sheet form, these materials can be in the form of a composite with a metallic matrix, such as aluminum. As noted above, boron fibers in the aluminum matrix also could perform some or all of the criticality safety function as well. The same is true of a matrix composed of aluminum and titanium diboride, zirconium diboride, or boron carbide particulates. Moreover, boron fibers can be combined with these ceramic particulates.

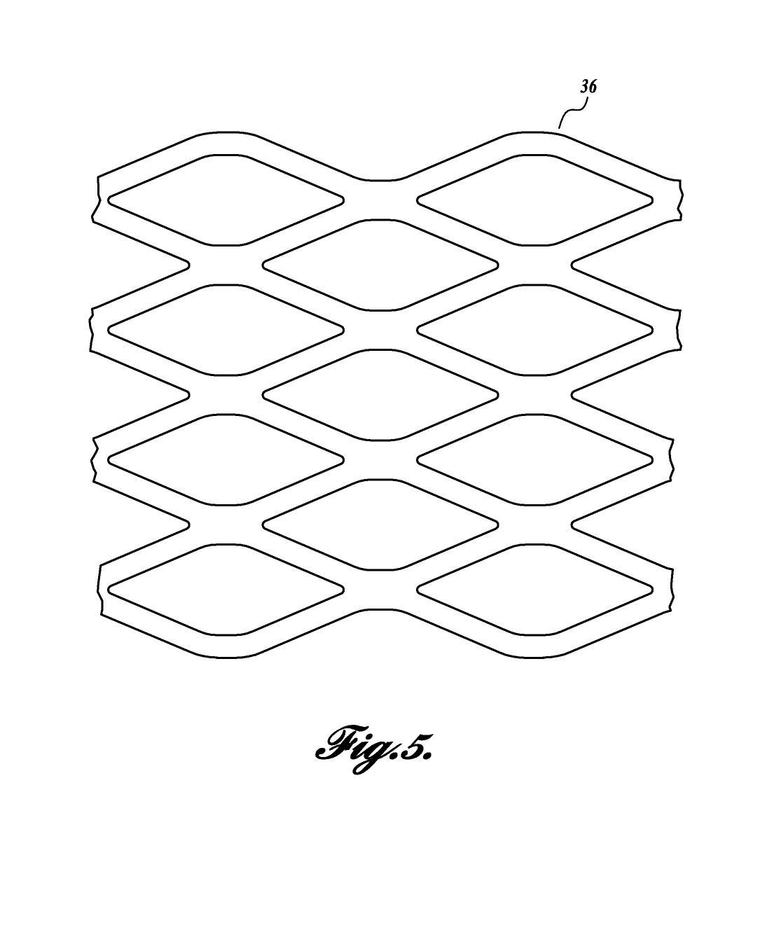

Also embedded in the cast composite 30 may be reinforcements 36, for example, steel bars or rods or steel mesh (see FIG. 5), that is encased in or otherwise integrated into the aluminum composite matrix 32. It should be appreciated, however, that reinforcements 36 are optional and may not be required for the basket assembly 10 to meet its required structural properties.

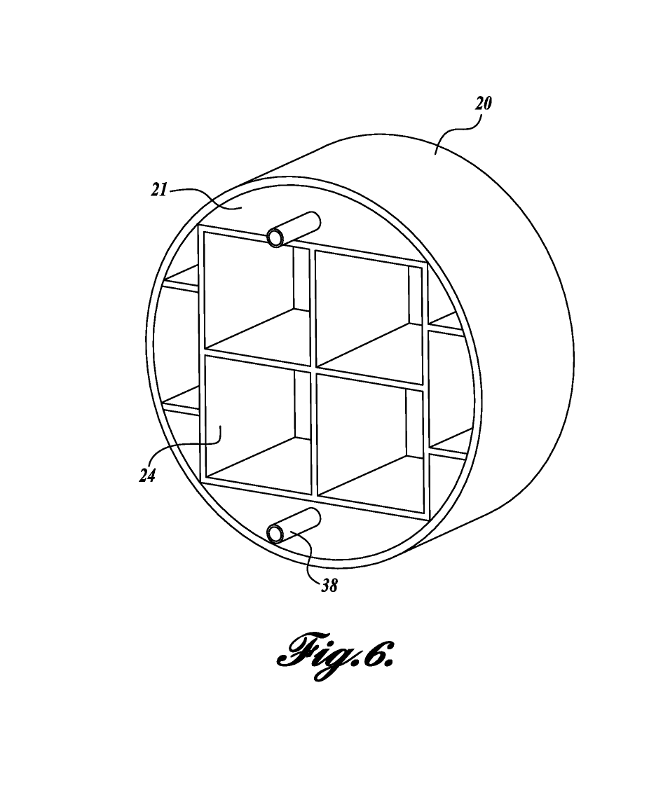

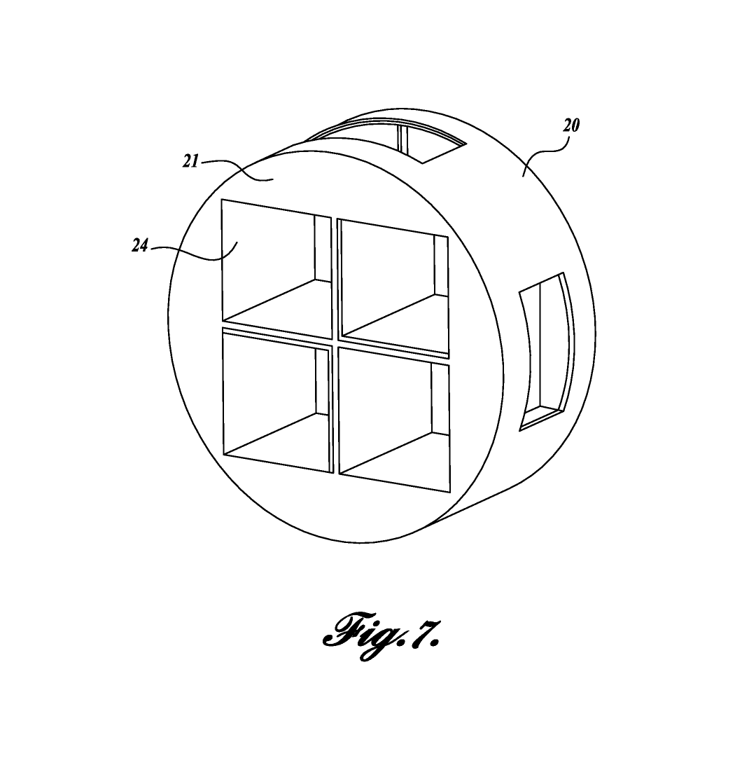

Referring to FIGS. 6 and 7, an exemplary steel or other high strength metal reinforcement 38 before casting and then after casting with aluminum composite are provided. (In the illustrated embodiment of FIGS. 6 and 7, the cast composite defines only four cells in the grid structure; however, it should be appreciated that any number of cells in the grid structure is within the scope of the present disclosure.)

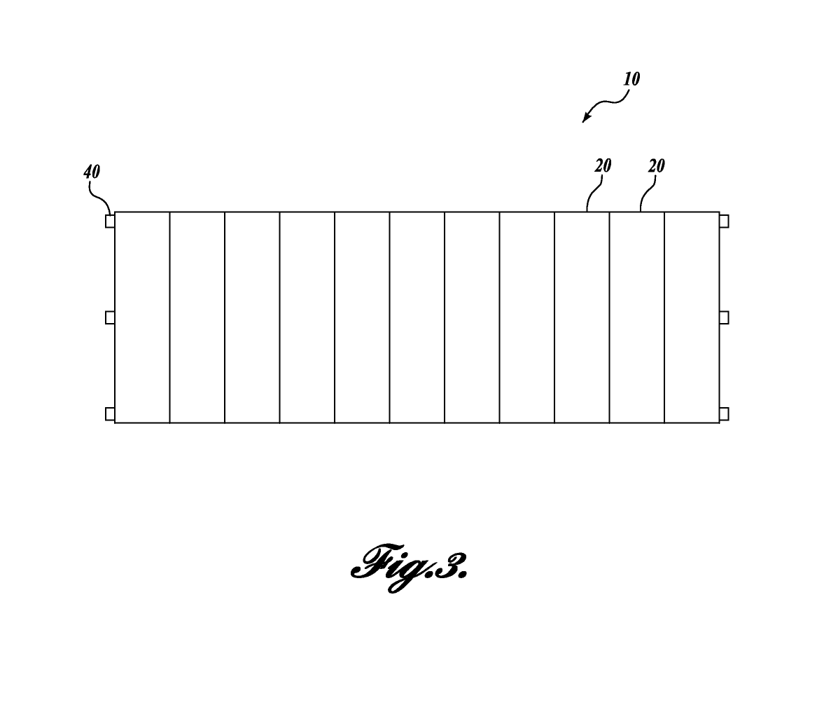

As can be seen in FIGS. 1 and 3, the casting composite 30 is formed in a disk 20 shape having a circular outer perimeter, a thickness defined by faces 21, and a grid structure 22 for receiving fuel containers. The grid structure 22 has a plurality of cells 24 and is substantially similar to the grid structure 122 in previously designed basket assemblies 110. In one embodiment of the present disclosure, the thickness of individual disks 20 may be in the range of about one to about two feet.

Because of the casting process, separate rails, such as rails 122 (see FIG. 8), are not required along the outer perimeter of the disk 20. Instead, the final exterior shape of the disk 20 can be achieved directly via the casting process.

To form full elongate cells 24 for receiving fuel containers, a plurality of disks 20 can be stacked or otherwise disposed together in direct face-to-face relationship to form the full height of a basket assembly 10 to be received within a container assembly; for example, container assembly C shown in FIG. 8. The disks 20 can then be placed in a container shell and fixed or tied together with axial steel or other metallic rods 40 (see FIGS. 1-3), or vice versa. The rods 40 engage through close fitting holes extending through the disks 20 at locations outwardly of the cells 24.

Although shown as a plurality of stacked disks 20 in FIGS. 1 and 3, it should be appreciated that any thickness reasonably within casting capabilities is within the scope of the present disclosure. For example, a full basket assembly 10 cast as a single elongate structure is also within the scope of the present disclosure. Such a single structure would present advantages to the system in terms of improved heat transfer and improved strength.

The casting process provides significant advantages to the composite basket assembly 10 as compared to previously designed basket assemblies 110. First, the casting process significantly reduces the number of components required for assembly to form the basket assembly, thereby providing great savings in time and assembly costs. Moreover, with reduced components comes a reduced risk of misassembly, resulting in a risk savings. Further, because the same mold or mold shape is used for each disk 20, the repeatability of the production process results in reduced manufacturing errors. Modifications to disks 20, if needed, are also simpler/easier to implement as a result of a single casting mold and the repeatability of the process.

Second, the thermal performance of the composite basket assembly 10 is significantly improved, as compared to thermal performance of previously designed basket assemblies 110. In that regard, because the composite basket assembly 10 is composed of disks 20 of a singular unitary structure, no gaps or distortions from welding occur in welded basket assemblies 110. Moreover, air gaps between adjacent plates occurring in welded basket assemblies 110 have been eliminated from the composite basket assembly 10, reducing the resistance to conductive or radiant heat transfer in the composite basket assembly 10. Therefore, heat transfer is primarily conductive and travels in a direct path radially and axially to be diffused from the basket assembly 10. Nonetheless, the basket structure described herein may also be used in a storage system designed to take advantage of convective cooling of the fuel.

In addition, the thermal conductivity of aluminum silicon carbide is about 130 W/m-K, whereas the thermal conductivity of stainless steel is about 16-20 W/m-K. Therefore, the primary material of the basket assembly 10 itself (for example, aluminum silicon carbide) increases the heat transfer capability of the basket assembly 10. Improved heat transfer performance also results in faster drying of the basket assembly 10 when, for example, transitioning from wet storage to dry storage.

Third, the composite basket assembly 10 of the present disclosure is lighter in weight than previously designed basket assemblies 110. In that regard, less steel is required in the construction to meet structural requirements of the basket assembly 10. Specifically, aluminum or aluminum composites used in the casting can contribute to the structural properties of the basket assembly 10, thereby requiring less structural steel than that required in previously designed basket assembly 110.

While illustrative embodiments have been illustrated and described, it will be appreciated that various changes can be made therein without departing from the spirit and scope of the disclosure.

The embodiments of the invention in which an exclusive property or privilege is claimed are defined as follows:

1. A composite basket assembly for a radioactive fuel assembly, the basket assembly comprising:
a plurality of cast disks having first and second faces spaced apart by the thickness of the disk, said cast disks constructed from aluminum or an aluminum composite and a neutron absorbing material;
wherein the neutron absorbing material is integrated into the aluminum or aluminum composite;
wherein the disk defines a plurality of holes extending through the thickness of the disk;
wherein the plurality of cast disks are disposed in face-to-face relationship to each other to form the composite basket assembly; and
wherein when the cast disks are disposed in face-to-face relationship to each other, the holes of the cast disks are in alignment with each other to define cells extending along the interior of the basket assembly for receiving radioactive fuel.

2. The basket assembly according to claim 1, further comprising reinforcing members composed of a material having higher strength than the aluminum or aluminum composite.

3. The basket assembly according to claim 2, wherein the reinforcing members are composed of steel.

4. The basket assembly according to claim 2, wherein the reinforcing members are composed of mesh steel.

5. The basket assembly according to claim 1, further comprising reinforcing embodiments disposed within the cast disks.

6. The basket assembly according to claim 5, wherein the reinforcing embodiments are selected from the group composed of steel members, mesh steel, boron fiber, and carbon fiber.

7. The basket assembly according to claim 1, wherein the cast disks are adjoined by connecting members extending through the cast disks.

8. The basket assembly according to claim 7, wherein the connecting members are composed of steel material.

9. The basket assembly according to claim 1, wherein the plurality of holes in the composite assemblies are arranged to form a grid structure for receiving elongated nuclear fuel assemblies.

10. The basket assembly according to claim 1, wherein the aluminum composite is selected from the group composed of aluminum with discontinuous reinforcement of silicon carbide, aluminum oxide, titanium diboride, or boron carbide powders.

11. The basket assembly according to claim 10, wherein the aluminum composite is reinforced with boron or carbon fibers.

12. The basket assembly according to claim 1, wherein the neutron absorbing material is composed of aluminum/boron carbide, boron carbide, aluminum diboride, titanium diboride, and zirconium diboride, either as pure material in sheet form or in the form of a composite with a metallic matrix such as aluminum.

13. The basket assembly according to claim 1, wherein the disks are cast to define a circular exterior shape.

14. A method of manufacturing a composite basket assembly for a nuclear fuel container assembly, the method comprising:
casting a plurality of cast disks from aluminum or aluminum alloy material and a neutron absorbing material, wherein the neutron absorbing material is integrated into the aluminum/aluminum alloy material, each of said disks having first and second faces separated by the thickness of the disk and a plurality of holes extending through the thickness of the disk; and
tying the plurality of disks together in face-to-face relationship to each other to form the composite basket assembly, wherein, when the disks are tied together, the holes of the disks are in alignment with each other to define cells extending along the interior of the basket assembly for receiving the nuclear fuel.

15. The method according to claim 14, wherein casting the plurality of disks comprises including reinforcing members integrated into the aluminum/aluminum alloy material, said reinforcing members having a higher strength than the aluminum/aluminum alloy material.

16. The method according to claim 15, wherein the reinforcing members are composed of a group consisting of steel, boron fibers, and carbon fibers.

17. The method according to claim 14, wherein the method of tying the disks together comprises utilizing axial connecting members extending through the cast disks.

18. The method according to claim 17, wherein the axial connecting members are composed of structural metal material rods.

19. The method according to claim 14, further comprising casting the plurality of disks to define an interior grid structure for receiving radioactive fuel containers.

20. The method according to claim 14, wherein the method of casting the plurality of disks comprises casting said disks from aluminum or an aluminum composite in a circular shape.

21. The method according to claim 14, wherein the aluminum alloy is aluminum with discontinuous reinforcement of silicon carbide, aluminum oxide, titanium diboride or boron carbide powders.

22. The basket assembly according to claim 21, wherein the aluminum alloy is reinforced with boron or carbon fibers.

23. The method of claim 14, wherein the neutron absorbing material is selected from the group consisting of aluminum/boron carbide, boron carbide, aluminum diboride, titanium diboride and zirconium diboride, either as pure material in sheet form or in the form of a composite with a metallic matrix such as aluminum.
